(19) United States
(12) Patent Application Publication
(10) Pub. No.: US 2014/0087239 A1
(43) Pub. Date: Mar. 27, 2014

(54) HERMETIC COIN CELL-TYPE ASSEMBLIES

(71) Applicant: MEDTRONIC, INC., Minneapolis, MN (US)

(72) Inventor: Brad C. Tischendorf, Minneapolis, MN (US)

(73) Assignee: MEDTRONIC, INC., Minneapolis, MN (US)

(21) Appl. No.: 13/628,347

(22) Filed: Sep. 27, 2012

(51) Int. Cl. H01M 2/08; H01M 6/12

(52) U.S. Cl. 429/162; 429/163

(57) ABSTRACT

A hermetic coin cell-type electrochemical cell having a housing made of a cover and base made of the same material and a glass seal wherein the glass used in the glass seal has a lower CTE than the CTE of the material used in the cover and the base.

### FIELD

The present disclosure relates to a hermetically sealed coin-cell type electrochemical cell.

### BACKGROUND

Implantable electrochemical cells are in widespread use. These cells are hermetically sealed using an insulating glass to separate the terminal pin from the case. Power sources of this type prevent internal components, such as the electrolyte, from coming into contact with body tissue or sensitive electrical components of the associated implantable medical device. These cells are easily manufactured in large sizes. However, as cell size becomes smaller, it becomes increasingly more complicated to perform the required welding and fabrication processes as the volume of the glass seal begins to consume a sizable fraction of the overall volume of the battery.

Often, coin cells are used in applications that require a very small power source. A top and bottom terminal crimped together with an insulating gasket characterized the general structure of coin cells. Contact between the electrodes and their current collectors are achieved by using stack pressure, which eliminates the need for welding the electrodes to the terminals. Also, since the number of parts is relatively small in a coin cell, this minimizes the need for many manufacturing operations. The problem with coin cells is, however, that the insulating gasket is typically of a polymeric or plastic material. Plastics are porous and do not constitute a hermetic seal. Also, these seals are unreliable and prone to leaking.

### SUMMARY

The coin cell-type electrochemical cells of this application utilize a glass seal to form a hermetic seal. In the embodiments described in this application, the coefficient of thermal expansion (α CTE) of the glass is lower than the α CTE of the material used to make the housing. Alternatively, the α CTE of the material used to make the housing is higher than the α CTE of the glass.

The coin cell-type electrochemical cells described in this application can be primary or secondary electrochemical systems.

In one embodiment, an electrochemical cell comprises a housing including a base and a cover, the base having a surrounding base sidewall and made from a conductive material, the cover having a surrounding cover sidewall and made from the same conductive material as the base and having α CTE, wherein the surrounding cover sidewall fits within the surrounding base sidewall with a space between the base and cover sidewalls, a first electrode material, a second electrode material, a separator between the first and second electrode materials within the housing, and a hermetic glass seal within the space between the surrounding base sidewall and the surrounding cover sidewall wherein the glass seal comprises a glass having α CTE that is lower than the CTE of the conductive material.

### BRIEF DESCRIPTION OF THE DRAWINGS

FIG. 1 is a depiction of a cross-section of an embodiment of a hermetic coin cell described in this application;

FIG. 2 is a depiction of a cross-section of another embodiment of a hermetic coin cell described in this application; and

FIG. 3 is a depiction of a cross-section of another embodiment of a hermetic coin cell described in this application . . . .

### DETAILED DESCRIPTION

As used herein, “coin cell” refers to a small and compact battery within a housing that can contain primary or secondary electrochemical configurations that can be circular, oval, square rectangular and any other geometric shape or volume.

As used herein, “LaBor-4” glass means a glass having the composition of about 30% B2O3, about 30-40% of a member selected from the group consisting of CaO, MgO, SrO and combinations thereof, with the proviso that the individual amounts of CaO and MgO are each not greater than about 20%; about 5% La2O3; about 10% SiO2; and about 15% Al2O3 wherein all percentages are mole percentages as described in U.S. Pat. No. 8,129,622.

In this disclosure it has been found that a hermetic glass seal can be made in a “coin-cell” type battery when the coefficient of thermal expansion (α CTE) of the glass is lower than that of the base and cover material.

The electrochemical or coin cells described in this application are suitable for use in small medical devices, such as small medical devices designed to be implanted or injected.

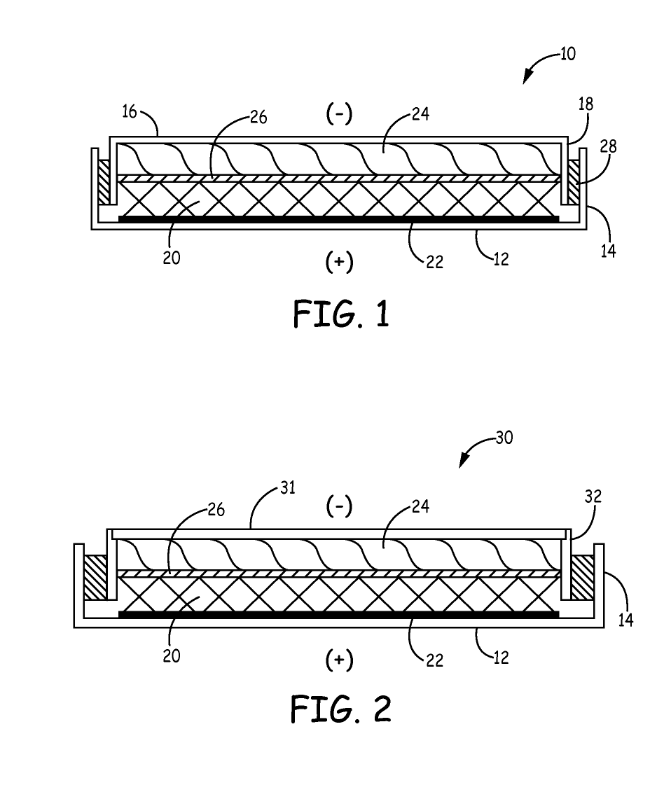

Referring now to FIG. 1, an embodiment of an electrochemical or coin cell 10 is depicted in cross section. Coin cell 10 comprises a base 12 having a surrounding base sidewall 14 and a cover 16 having a surrounding cover sidewall 18. Within the base 12 is a first electrode material 20 and a current collector 22 contacting the base wall and the first electrode material. Within the cover 16 is a second electrode material 24. A separator 26 contacts and is in between the first electrode material 20 and the second electrode material 24. A glass seal 28 is within the space between the surrounding base sidewall 14 and the surrounding cover sidewall 18

In this embodiment, the base and surrounding base sidewall comprises a single or unitary part and the cover and surrounding cover sidewall comprises a single or unitary part. In this embodiment, the first electrode material 20 is depicted as the positive electrode and the second electrode material 24 is depicted as the negative electrode. However, the electrochemical cells of this disclosure may also be configured such that the polarity of the electrode materials can be the reverse of what is depicted in FIG. 1.

FIG. 2 depicts a cross-section of another embodiment of an electrochemical or coin cell. The same reference numbers will be used to refer to the same parts or elements depicted in the figures. Coin cell 30 comprises a base 12 having a surrounding base sidewall 14 and a cover plate 31 attached to a surrounding cover plate sidewall 32. In this embodiment, the cover plate 30 and the surrounding cover plate sidewall 32 are separate elements or parts. Such a design, allows for an alternate assembly process of the coin cell, described in more detail below.

As in FIG. 1, coin cell 30 of FIG. 2 comprises a first electrode 20 and current collector 22 within the base and second electrode 24 within the cover plate 31/cover plate sidewall 32 and a separator 26 between the first and second electrode materials. A glass seal 28 is within the space between the surrounding base sidewall 14 and the surrounding cover plate sidewall 32.

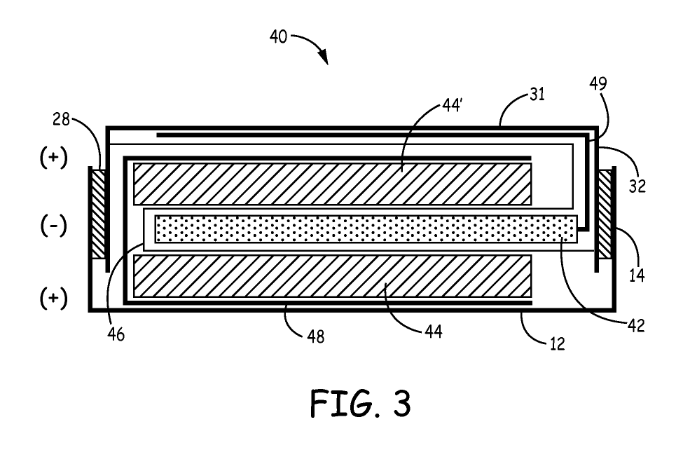

FIG. 3 depicts an embodiment of an electrochemical or coin cell having multiple electrode combinations. Coin cell 40 comprises a base 12 having a surrounding base sidewall 14 and a cover plate 30 attached to a surrounding cover plate sidewall 32. Second electrode material 42 is spatially between first electrode materials 44, 44′. Separator 46 contacts and is in between first electrode materials 44, 44″ and second electrode material 42. A first electrode current collector 48 contacts both first electrode materials 44, 44′ and base 12. A second electrode current collector 49 contacts second electrode material and cover plate 31 and cover plate sidewall 32. A glass seal 28 is within the space between the surrounding base sidewall 14 and the surrounding cover plate sidewall 32.

In the embodiment of FIG. 3, the first electrode material 44, 44′ is depicted as the positive electrode and the second electrode material 42 is depicted as the negative electrode. In this embodiment, the base and surrounding base sidewall comprises a single or unitary part and the cover and surrounding cover sidewall comprises a single or unitary part. However, the surround cover sidewalls and the cover plate could be separate parts if desired.

The base including the sidewall and the cover and cover plate including the sidewall typically comprises a conductive material for example, titanium, stainless steel, niobium, aluminum, alloys of any of them and both the base and the cover are made from the same material. Useful base and cover (housing) materials have an α CTE in a range selected such that they have α CTE about 10% or more higher than the α CTE of the glass used in the glass seal. In other embodiments, base and cover material have an α CTE in a range selected such that they have a CTE of 11%, 12%, 13%, 14%, 15%, 16%, 17%, 18%, 19%, 20%, 21%, 22%, 23%, 24%, 25%, 26%, 27%, 28%, 29%, 30%, or any range from 10% to 30% inclusive, including fractions of 1% higher than the α CTE of the glass used in the glass seal.

The above glass, base, and cover cell arrangement described in this application is different than a standard graded hermetic glass seal arrangement where the outer cover material has the highest CTE, the inner base material has the lowest CTE, and the glass material has α CTE in between those of the cover and base. For example, if standard lithium battery materials are used in such a design (for example outer cover Ti/304SS, CaBAl-12 glass, and inner base molybdenum), finite element analysis modeling performed by applicant show that well more than 50% of the length of the glass seal is under tensile loading with the majority of that under stress greater than the approximate 34.5 MPa tensile strength of the glass. By changing to the design set with matching materials at inner and outer rings and an appropriate glass material, for example, LaBor-4 glass as described in this application, applicant found through finite element analysis modeling that less than half of the length of the glass seal is under tension and none of the length of the glass seal is above the approximate 34.5 MPa tensile strength of the glass.

Useful glass materials for the hermetic glass seal include, for example LaBor-4 glass, CaBAl-12, and ALSG (Pb-free phosphate glasses) such as those described in U.S. Pat. No. 5,965,469 and U.S. Pat. No. 6,037,539, both incorporated herein for the description of such ALSG glasses. CABAL-12 glass consists primarily of aluminum oxide (Al2O3):boron oxide (B2O3):calcium oxide (CaO):magnesium oxide (MgO), for example, with relative approximate concentrations of 20:40:20:20 (mol %), and sodium oxide (Na20), potassium oxide (K20), silicon oxide (Si02) and arsenic oxide (As203) at maximum concentrations of thousands parts per million.

The coin cell-type assemblies described in this application can be either a primary chemistry or a secondary, rechargeable chemistry. For both the primary and secondary types, the anode active metal is selected from Groups IA, IIA and IIIB of the Periodic Table of the Elements, including lithium, sodium, potassium, etc., and their alloys and intermetallic compounds including, for example, Li—Si, Li—Al, Li—B, Li—Mg, and Li—Si—B alloys. An alternate negative electrode comprises a lithium alloy, such as lithium-aluminum alloy.

For a primary coin cell, the anode is a thin metal sheet or foil or pellet of the lithium material. In secondary electrochemical systems, the anode or negative electrode comprises an anode material capable of intercalating and de-intercalating the anode active material, such as the metal lithium.

A carbonaceous negative electrode comprising any of the various forms of carbon (e.g., coke, graphite, acetylene black, carbon black, glassy carbon, etc.), which are capable of reversibly retaining the lithium species, is useful. A “hairy carbon” material is useful due to its relatively high lithium-retention capacity. “Hairy carbon” is a material described in U.S. Pat. No. 5,443,928 to Takeuchi et al. Graphite is another useful material. Regardless of the form of the carbon, fibers of the carbonaceous material are useful because they have excellent mechanical properties, which permit them to be fabricated into rigid electrodes that are capable of withstanding degradation during repeated charge/discharge cycling. Moreover, the high surface area of carbon fibers allows for rapid charge/discharge rates.

A typical negative electrode for a secondary cell is fabricated by mixing about 90 to 97 weight percent of a binder material, which is for example, a fluoro-resin powder such as polytetrafluoroethylene (PTFE), polyvinylidene fluoride (PVDF), polyethylenetetrafluoroethylene (ETFE), polyamides, polyimides, and mixtures thereof.

Carbonaceous active materials are typically prepared from carbon and fluorine, which includes graphitic and nongraphitic forms of carbon, such as coke, charcoal or activated carbon. Fluorinated carbon is represented by the formula (CFₓ)ₙ, wherein x varies between about 0.1 to 1.9 and also between about 0.5 and 1.2, and (C₂F)ₙ, wherein n refers to the number of monomer units, which can vary widely.

The metal oxide or the mixed metal oxide is produced by the chemical addition, reaction, or otherwise intimate contact of various metal oxides, metal sulfides and/or metal elements, preferably during thermal treatment, sol-gel formation, chemical vapor deposition or hydrothermal synthesis in mixed states. The active materials thereby produced contain metals, oxides and sulfides of Groups IB, IIB, IIIB, IVB, VB, VIIB, VIIB and VIII, which include the noble metals and/or other oxide and sulfide compounds. A useful cathode active material is a reaction product of at least silver and vanadium.

In addition to the previously described fluorinated carbon, silver vanadium oxide and copper silver vanadium oxide, Ag₂O, Ag₂O₂, CuF₂, Ag₂CrO₄, MnO₂, V₂O₅, MnO₂, TiS₂, Cu₂S, FeS, FeS₂, copper oxide, copper vanadium oxide, and mixtures thereof are contemplated as useful active materials.

In secondary coin cell, the positive electrode typically comprises a lithiated material that is stable in air and readily handled. Examples of such air-stable lithiated cathode active materials include oxides, sulfides, selenides, and tellurides of such metals as vanadium, titanium, chromium, copper, molybdenum, niobium, iron, nickel, cobalt and manganese. Useful oxides include LiNiO₂, LiMn₂O₄, LiCoO₂, LiCO_{0.92}Sn_{0.08}O₂ and LiCo₁₋ₓNiₓO₂.

The separator is of an electrically insulative material to prevent an internal electrical short circuit between the electrodes, and also is chemically unreactive with the anode and cathode active materials and both chemically unreactive with an insoluble in the electrolyte. In addition, the separator material has a degree of porosity sufficient to allow flow there through of the electrolyte during the electrochemical reaction of the cell. The form of the separator typically is a sheet placed between the anode and cathode electrodes. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company Inc.), and a membrane commercially available under the designation DEXIGLAS (C.H. Dexter, Div., Dexter Corp.).

Suitable nonaqueous electrolytes comprising an inorganic salt dissolved in a nonaqueous solvent, and an alkali metal salt dissolved in a mixture of aprotic organic solvents comprising a low viscosity solvent including organic esters, ethers and dialkyl carbonates, and mixtures thereof, and a high permittivity solvent including cyclic carbonates, cyclic esters and cyclic amides, and mixtures thereof. Suitable nonaqueous solvents are substantially inert to the anode and cathode electrode materials and examples of low viscosity solvents include tetrahydrofuran (THF), methyl acetate (MA), diglyme, triglyme, tetraglyme, dimethy carbonate (DMC), diethyl carbonate (DEC), dipropyl carbonate (DPC), methyl ethyl carbonate (MEC), methyl propyl carbonate (MPC), ethyl propyl carbonate (EPC), 1,2-Dimethoxyethane (DME), and mixtures thereof. Preferred high permittivity solvents include propylene carbonate (PC), thylene carbonate (EC), butylenes carbonate (BC), acetonitrile, dimethyl sulfoxide, dimethyl formamide, dimethyl acetamide, γ-butyrolactone (GBL), γ-valerolactone, N-methyl-pyrrolidinone (NMP), and mixtures thereof.

Known lithium salts that are useful as a vehicle for transport of alkali metal ions from the anode to the cathode, and back again include LiPF₆, LiBF₄, LiAsF₆, LiSbF₆, LiClO₄, LiAlCl₄, LiGaCl₄, LiC(SO₂CF₃)₃, LiO₂, LiNO₃, LiO₂CCF₃, LiN(SO₂CF₃)₂, LiSCN, LiO₃SCF₂CF₃, LiC₆F₅SO₃, LiO₂CF₃, LiSO₃F, LiB(C₆H₅)₄, LiCF₃SO₃, and mixtures thereof.

The coin cells as described in this application can be assembled by at least two methods. For example, the coin cell as depicted in FIG. 1 can be assembled by inserting the electrode materials and the separator within the base and the cover, inserting the glass seal in the form of a solid preform between the sidewalls, exerting pressure upon the cover, and then heating the glass preform using directed energy heating, for example, using directed laser energy. Directed energy heating can be used in such a manner to minimize overall heating of the coin cell and preventing damage to the internal electrode and separator materials.

The coin cell depicted in FIG. 2 can be assembled by placing a solid glass preform between the base sidewall and the cover plate sidewall and heating the sub-assembly in a furnace to create a hermetic glass seal. Then the internal electrode materials and separator and any other components can be placed within the subassembly, and the cover can be attached by welding.

The coin cell depicted in FIG. 3 can be assembled using the method described above for the coin cell depicted in FIG. 1. In this case, the current collector 48, first electrode material 44, separator 46, second anode material 42, separator 46, first electrode material 44′ current collector and separator 46 are placed into the base 12. A glass seal in the form of a solid preform is inserted between the sidewalls, exerting pressure upon the cover, and then heating the glass preform using directed energy heating, for example, using directed laser energy. In the coin cell depicted in FIG. 3 the separator and the current collectors are of such lengths to be folded to separate the negative electrode from the positive electrodes, and to connect the positive electrodes with the base and to connect the negative electrode with the cover, respectively. Of course, the coin cell depicted in FIG. 3 could also be assembled using the method described above for the coin cell depicted in FIG. 2.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that exemplary embodiments may be embodied in many different forms and that neither should be construed to limit the scope of the disclosure. In some exemplary embodiments, well-known processes, well-known device structures, and well-known technologies are not described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. An electrochemical cell comprising:
a. a housing having a base and a cover, the base having a surrounding base sidewall and made from a conductive material and the cover having a surrounding cover sidewall and made from the same conductive material as the base and having a CTE, wherein the surrounding cover sidewall fits within the surrounding base sidewall with a space between the base and cover sidewalls;
b. a first electrode material;
c. a second electrode material;
e. a separator between the first and second electrode materials, the first and second electrode materials and the separator within the housing; and
f. a hermetic glass seal within the space between the surrounding base sidewall and the surrounding cover sidewall wherein the glass seal comprises a glass having a CTE that is lower than the CTE of the conductive material, wherein the conductive material has a CTE that is 10% to 30% higher than the CTE of the glass.

2. The electrochemical cell of claim 1 wherein the conductive material comprises titanium, niobium, aluminum, or stainless steel.

3. The electrochemical cell of claim 1 wherein the glass is LaBor-4, CaBal-12, or ALSG glass.

4. The electrochemical cell of claim 1 wherein the second electrode material is lithium.

5. The electrochemical cell of claim 1 wherein the first electrode material is SVO/CFx hybrid material.

6. The electrochemical cell of claim 1 further comprising an additional first electrode material within the housing, the second electrode material being between the first electrode materials.

7. The electrochemical cell of claim 1 wherein the cover plate and the surrounding cover sidewall are separate parts.

8. The electrochemical cell of claim 1 wherein the first electrode material is a lithiated metal oxide.

9. The electrochemical cell of claim 1 wherein the second electrode is a carbonaceous material.

10. A housing for an electrochemical cell comprising:
a. a base having a surrounding base sidewall and made from a conductive material;
b. a cover having a surrounding cover sidewall and made from the same conductive material as the base and having a CTE, wherein the surrounding cover sidewall fits within the surrounding base sidewall with a space between the base and cover sidewalls; and
c. a hermetic glass seal within the space between the surrounding base sidewall and the surrounding cover sidewall wherein the glass seal comprises a glass having a CTE that is lower than the CTE of the conductive material, wherein the conductive material has a CTE that is 10% to 30% higher than the CTE of the glass.

11. The housing of claim 10 wherein the conductive material comprises titanium, niobium, aluminum, or stainless steel.

12. The housing of claim 10 wherein the glass is LaBor-4, CaBal-12, or ALSG glass.
